(19) United States
(12) Patent Application Publication
(10) Pub. No.: US 2025/0180459 A1
(43) Pub. Date: Jun. 5, 2025

(54) Using Variable Voltage and Current Rate of Change to Measure Particulate Matter Sensors

(71) Applicant: Emisense Technologies, LLC, Ladera Ranch, CA (US)

(72) Inventors: Joseph Fitzpatrick, Glendale, CA (US); Patrick Thompson, Ladera Ranch, CA (US)

(21) Appl. No.: 19/047,537

(22) Filed: Feb. 6, 2025

Related U.S. Application Data
(63) Continuation of application No. 17/491,514, filed on Sep. 30, 2021.
(60) Provisional application No. 63/086,024, filed on Sep. 30, 2020.

(51) Int. Cl. G01N 15/06; G01M 15/10; G01N 15/00

(52) U.S. Cl. CPC G01N 15/0656; G01M 15/102; G01N 2015/0046

(57) ABSTRACT

A method for analysis of a gas stream includes adjusting a voltage to a particulate matter sensor, the particulate matter sensor having an agglomeration of particulate matter. The method includes measuring a first rate of current change caused by adjusting the voltage, wherein the first rate of current change is proportional to the concentration of the agglomeration of particulate matter.

### CROSS-REFERENCE TO RELATED APPLICATIONS

This application claims the benefit of U.S. Provisional Application No. 63/086,024, filed on Sep. 30, 2020, which is incorporated by reference herein in its entirety.

### BACKGROUND

Increasingly stringent emissions regulations require automobile manufacturers to develop comprehensive on-board diagnostic (OBD) systems for exhaust gas monitoring. Compact, inexpensive sensors are particularly in demand for monitoring and control of regulated pollutants including hydrocarbons, carbon monoxide, and oxides of nitrogen (NO) and other pollutants. Many sensors for these applications have been proposed based on various technologies.

Some conventional particulate matter (PM, e.g., soot) monitoring systems apply a fixed high voltage (1000 VDC) to a cylindrical electrode and then repeatedly measures current between the isolated (galvanic) high voltage supply and chassis ground on the test vehicle. However, the system relies on first collecting soot (electrostatically trapping) and then utilizing the formed aggregates to produce a larger current signal than would be normally expected from the natural charge of the PM particles. This means that there is a non-trivial lag in signal formation.

The lag is more pronounced with brand new electrodes, but even previously operated sensors can take 600 seconds or more for the signal to fully develop even in a high soot concentration and potentially hours at low concentrations of soot. Further, this signal development can be disrupted by transient events (e.g., changes in gas flow in the exhaust among other events). These two factors along with others make sensor operation itself hard to continuously verify.

There are several other factors that also might be considered. Although the current is large compared to the natural charge of the soot, the signal is still quite small (approximately 4 nA per 1 mg/m\hat{ }3 of soot) in absolute terms, so processing steps must be taken to mitigate surface and bulk leakage in the probe. In one example, 1 gig ohm of leakage in the probe would equal 1000 nA of signal at 1000V, which can be about 250 times larger than the size of the measured current.

In addition, the collection of soot can lead to fouling of the probe. Also, the exact current for a given concentration of soot can vary from day to day. Embodiments of devices and processes described herein address some or all of these potential issues

### SUMMARY

The subject matter of the present application has been developed in response to the present state of the art, and in particular, in response to the problems and disadvantages associated with conventional deposition that have not yet been fully solved by currently available techniques. Accordingly, the subject matter of the present application has been developed to provide embodiments of a system, an apparatus, and a method that overcome at least some of the shortcomings of prior art techniques.

Disclosed herein is a method. A method for analysis of a gas stream includes adjusting a voltage to a particulate matter sensor, the particulate matter sensor having an agglomeration of particulate matter. The method includes measuring a first rate of current change caused by adjusting the voltage, wherein the first rate of current change is proportional to the concentration of the agglomeration of particulate matter. The preceding subject matter of this paragraph characterizes example 1 of the present disclosure.

The method includes adjusting the voltage to the particulate matter sensor a second time and measuring a second rate of current change caused by adjusting the voltage the second time, wherein the second rate of current change is proportional to the concentration of agglomeration of particulate matter. The preceding subject matter of this paragraph characterizes example 2 of the present disclosure, wherein example 2 also includes the subject matter according to example 1, above.

The adjusting the voltage to the particulate matter sensor comprises increasing the voltage. The adjusting the voltage to the particulate matter sensor the second time comprises decreasing the voltage. The preceding subject matter of this paragraph characterizes example 3 of the present disclosure, wherein example 3 also includes the subject matter according to any one of examples 1-2, above.

The adjusting the voltage to the particulate matter sensor comprises decreasing the voltage after a fixed interval of time of a constant voltage. The preceding subject matter of this paragraph characterizes example 4 of the present disclosure, wherein example 4 also includes the subject matter according to any one of examples 1-3, above.

The adjusting the voltage to the particulate matter sensor comprises increasing the voltage to a range between 1 kilovolt and 1.6 kilovolts. The preceding subject matter of this paragraph characterizes example 5 of the present disclosure, wherein example 5 also includes the subject matter according to any one of examples 1-4, above.

The method includes turning off the voltage and measuring a fall rate of the current. The preceding subject matter of this paragraph characterizes example 6 of the present disclosure, wherein example 6 also includes the subject matter according to any one of examples 1-5, above.

The method includes adjusting the voltage to the particulate matter sensor intermittently. The preceding subject matter of this paragraph characterizes example 7 of the present disclosure, wherein example 7 also includes the subject matter according to any one of examples 1-6, above.

The method includes measuring the rate of current change intermittently. The preceding subject matter of this paragraph characterizes example 8 of the present disclosure, wherein example 8 also includes the subject matter according to any one of examples 1-7, above.

The method includes adjusting the voltage to the particulate matter sensor periodically. The preceding subject matter of this paragraph characterizes example 9 of the present disclosure, wherein example 9 also includes the subject matter according to any one of examples 1-8, above.

The method includes measuring the rate of current change periodically. The preceding subject matter of this paragraph characterizes example 10 of the present disclosure, wherein example 10 also includes the subject matter according to any one of examples 1-9, above.

The adjusting the voltage to the particulate matter sensor comprises increasing the voltage. The preceding subject matter of this paragraph characterizes example 11 of the present disclosure, wherein example 11 also includes the subject matter according to any one of examples 1-10, above.

The adjusting the voltage to the particulate matter sensor comprises decreasing the voltage. The preceding subject matter of this paragraph characterizes example 12 of the present disclosure, wherein example 12 also includes the subject matter according to any one of examples 1-11, above.

The adjusting the voltage to the particulate matter sensor comprises decreasing the voltage after a fixed interval of time of a constant voltage. The preceding subject matter of this paragraph characterizes example 13 of the present disclosure, wherein example 13 also includes the subject matter according to any one of examples 1-12, above.

The adjusting the voltage to the particulate matter sensor comprises increasing the voltage to a range between 1 kilovolt and 5 kilovolts. The preceding subject matter of this paragraph characterizes example 14 of the present disclosure, wherein example 14 also includes the subject matter according to any one of examples 1-13, above.

The method includes turning off the voltage and measuring a fall rate of the current. The preceding subject matter of this paragraph characterizes example 15 of the present disclosure, wherein example 15 also includes the subject matter according to any one of examples 1-14, above.

The method incudes adjusting the voltage to the particulate matter sensor intermittently and further comprising measuring the rate of current change intermittently. The preceding subject matter of this paragraph characterizes example 16 of the present disclosure, wherein example 16 also includes the subject matter according to any one of examples 1-15, above.

The method includes adjusting the voltage to the particulate matter sensor periodically and further comprising measuring the rate of current change periodically. The preceding subject matter of this paragraph characterizes example 17 of the present disclosure, wherein example 17 also includes the subject matter according to any one of examples 1-16, above.

A device for analysis of a gas stream is disclosed. The device includes a particulate matter sensor, a voltage generator to generate an adjustable voltage, and a detector configured to detect a rate of current change caused by an adjustable voltage. The preceding subject matter of this paragraph characterizes example 18 of the present disclosure.

The voltage generator is configured to increase or decrease the voltage. The preceding subject matter of this paragraph characterizes example 19 of the present disclosure, wherein example 19 also includes the subject matter according to examples 18, above.

The voltage generator is configured to adjust the voltage intermittently. The preceding subject matter of this paragraph characterizes example 20 of the present disclosure, wherein example 20 also includes the subject matter according to any one of examples 18-19, above.

Other aspects and advantages of embodiments of the present invention will become apparent from the following detailed description, taken in conjunction with the accompanying drawings, illustrated by way of example of the principles of the invention.

### BRIEF DESCRIPTION OF THE DRAWINGS

In order that the advantages of the subject matter may be more readily understood, a more particular description of the subject matter briefly described above will be rendered by reference to specific embodiments that are illustrated in the appended drawings. Understanding that these drawings depict only typical embodiments of the subject matter and are not therefore to be considered to be limiting of its scope, the subject matter will be described and explained with additional specificity and detail through the use of the drawings, in which:

FIG. 1 depicts a schematic block diagram of one embodiment of an exhaust sensor system.

FIG. 2A depicts a schematic diagram of an exterior of one embodiment of the sensor assembly of FIG. 1.

FIG. 2B depicts a schematic diagram of an interior of one embodiment of the sensor assembly of FIG. 1.

FIG. 2C depicts a schematic diagram of a flow pattern through the interior of the sensor assembly of FIG. 2B.

FIG. 2D depicts a schematic diagram of another embodiment of the sensor assembly of FIG. 1.

FIG. 3 depicts a schematic circuit diagram of one embodiment of the control circuit of FIG. 1.

FIG. 4 depicts a schematic circuit diagram of another embodiment of the control circuit of FIG. 1.

FIG. 5 depicts a schematic circuit diagram of the sensor assembly of FIG. 1.

FIG. 6 depicts one embodiment of a flow chart diagram of a method.

FIG. 7 depicts one embodiment of a flow chart diagram of a method for analysis of a gas stream.

FIG. 8 depicts a graphical representation of current and buildup over time.

FIG. 9 depicts a graphical representation of current and buildup over time.

FIG. 10 depicts a particulate matter sensor according to one or more embodiments described herein.

Throughout the description, similar reference numbers may be used to identify similar elements.

### DETAILED DESCRIPTION

It will be readily understood that the components of the embodiments as generally described herein and illustrated in the appended figures could be arranged and designed in a wide variety of different configurations. Thus, the following more detailed description of various embodiments, as represented in the figures, is not intended to limit the scope of the present disclosure, but is merely representative of various embodiments. While the various aspects of the embodiments are presented in drawings, the drawings are not necessarily drawn to scale unless specifically indicated.

The present invention may be embodied in other specific forms without departing from its spirit or essential characteristics. The described embodiments are to be considered in all respects only as illustrative and not restrictive. The scope of the invention is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussions of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize, in light of the description herein, that the invention can be practiced without one or more of the specific features or advantages of a particular embodiment. In other instances, additional features and advantages may be recognized in certain embodiments that may not be present in all embodiments of the invention.

Reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While many embodiments are described herein, at least some of the described embodiments facilitate faster sensor readings in the detection of pollutant gases in a hot, flowing gas stream. Some embodiments include utilizing a particulate matter sensor. Some embodiments include adjusting a voltage instead of keeping a constant voltage. The adjustment may be increasing voltage or decreasing voltage in some embodiments. In some embodiments, a voltage is removed. Many different ways of adjusting or changing voltage are envisioned.

Removing a signal by lowering voltage causes changes including in some embodiments, a rate of current change. Current that is soot induced should lower following a field change type curve. System leakage like bulk leakage, surface leakage, etc. should follow ohms law. So, when lowering voltage the soot provided signal should drop rapidly (basically exponentially), then the current should follow a resistive curve for leakage. In some embodiments, the system constantly self corrects for non-signal leakages (surface leakage and bulk leakage

In addition, some embodiments allow for a higher voltage to be used as it is changing intermittently or periodically. At high voltages, dendrite growth can be accelerated. Embodiments may utilize a voltage (highest possible) that does not arc. In some embodiments, a variable voltage system could induce amplification with the highest voltage that does not arc under current engine and atmospheric conditions. This presumably would shorten light off time and reduce transient disruptions. In some embodiments, the high voltage is up to 5 kilovolts. In some embodiments, the high voltage is up to 4 kilovolts. In some embodiments, the high voltage is up to 3 kilovolts. In some embodiments, the high voltage is up to 2 kilovolts. In some embodiments, the high voltage is up to 1.5 kilovolts. Systems may be used also in spark ignition systems up to 5 kilovolts.

Expedited or accelerated growth is available at higher voltages and because such voltages are for limited times and variability, readings can be conducted quickly and estimated for buildup at a certain voltage.

Some embodiments measure the rate of change of a current. In some embodiments, the rise time is measured. In some embodiments, the fall time is measured (e.g., measuring the decay). Some embodiments allow for less buildup on the sensor as voltage can be cut off.

In some embodiments, the system may measure bulk leakage. In some embodiments, the system may measure current leakage. In some embodiments, the rate of current change is measured using a development of current amplification.

In the course of investigating frequency-domain impedance metric modes of operation, a surprising discovery occurred when employing inexpensive digital electronics to monitor the rate of change of current during voltage adjustments.

The adjustment may be an increasing of voltage or decreasing voltage. The voltage may be adjusted in a repeating manner, either intermittently or periodically increasing and decreasing voltage.

Some embodiments allow for enhanced self-calibration. In traditional sensors with a constant voltage, errors would build up in readings. Periodically or intermittently zeroing out the voltage allows for the system to periodically cancel out drift or aging. The system is able to continuously find or re-find zero.

In addition, embodiments facilitate resistance to buildup of agglomeration on the sensor. The dynamic changes of voltage combats fouling and can spark away agglomeration

By measuring a rate of change, the slope may allow A source wave was applied to a sensor that was subjected to a gas stream, and a corresponding response wave was obtained. The source and response waves exhibited similar peak-to-peak values indicating that no phase angle shift or phase angle difference occurred.

In contrast, previous impedance metric modes of operation in the frequency-domain used expensive electrochemical equipment that indicated phase angle changes. Nevertheless, the distortion of the response wave in the low-cost digital electronics did result in a time-voltage differential at the zero-crossing, as well as at non-zero magnitudes.

Furthermore, using the time-voltage differential in the time-domain allowed for larger amplitude signals indicating the potential for higher sensitivity toward NOₓ and lower constraints for specified material compositions and microstructures to achieve different levels of performance. Thus, it was discovered that the use of time-voltage differentials in the time-domain allows for more sensor design flexibility.

A digital method for operating embodiments of solid-state electrochemical gas sensors using time-domain measurements may have advantages over conventional direct current (DC) methods such as potentiometric and amperometric sensors, as well as other alternating current (AC) methods such as frequency-domain impedance metric sensors.

In some embodiments, the applied signal is an AC waveform. The applied signal may be any type of symmetrical or asymmetrical AC waveform. In some examples, particular waveforms such as sinusoidal or triangular waveforms may be applied. In some embodiments, alternate waveform shapes (i.e., other than a sinusoidal waveform) may produce larger response signals.

In some embodiments, the response of the solid-state electrochemical gas sensor is digitally measured as a voltage-current time differential as indicated by the time domain zero-crossing. In other embodiments, the voltage-current time differential is monitored at another specified non-zero magnitude. In some embodiments, measurement of the voltage-current time differential at specific points of magnitude other than the zero-crossing produces larger signals. Additionally, the application of a particular type of waveform, or a waveform with specific characteristics, may influence the sensitivity or other characteristic of the response signal that is detected. For example, in some embodiments, the application of a triangular waveform may result in high sensitivities and large sensor signals.

In some embodiments, the digital time-domain method can be used for simultaneous measurement of multiple gas species and/or environmental variations such as temperature. For example, in a single wave cycle, the system is capable of measuring multiple species of gases within an exhaust stream. As another example, the detection of part-per-million (ppm) levels of NOₓ (e.g., NO and NO₂) as well as temperature in automotive exhaust may be done through the application of both triangular and sine waveforms. In another example, asymmetric signals and multiple voltage-current time differentials can be used to extract measurements of multiple gas species simultaneously. In yet another example, combining changes in source wave frequency can be used to extract temperature information of the sensor and/or the gas stream.

In further embodiments, certain material and design features can be identified specifically for detecting NOₓ using a solid-state electrochemical sensor that are based on reaction mechanisms responsible for sensing. However, the potential applications for the embodiments described herein are significantly broader in terms of the types of gas species that can be detected (e.g., oxygen, nitrogen dioxide, hydrocarbons, etc.) and are also not necessarily limited to solid-state electrochemical gas sensors.

Development of this technology is of interest to various vehicle technologies. And embodiments of this technology have primary, short-term applications for on-board monitoring of vehicle (especially diesel) emissions. However, while many embodiments described herein specifically refer to the monitoring of industrial exhaust gases and vehicle emissions, broader applications are available in any area where electrochemical sensors are of interest. For example, some embodiments described herein may be employed in medical, health & safety, and environmental applications.

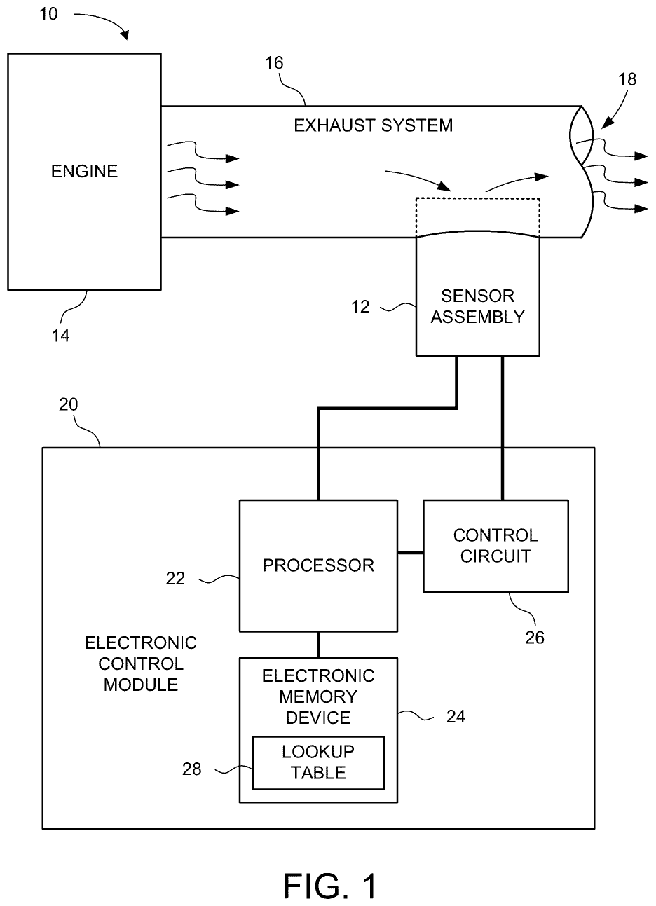

FIG. 1 depicts a schematic block diagram of one embodiment of an exhaust sensor system 10. The illustrated exhaust sensor system 10 includes a sensor assembly 12, an engine 14, and an exhaust system 16. The engine 14 produces exhaust which moves through the exhaust system 16. The exhaust system 16 facilitates flow of the exhaust gases to a gas outlet 18, typically for emission into the atmosphere. The sensor assembly 12 is at least partially inserted into the exhaust system 16 to detect a parameter within the exhaust stream. As the gas in the exhaust system 16 passes over and/or through the sensor assembly 12, the sensor assembly 12 detects a condition within the exhaust by measuring chemicals or temperature or other parameters at the sensor assembly 12, as described herein. In a specific embodiment, the sensor assembly 12 includes a particulate matter sensor to detect conditions indicative of the presence of particulate matter within the exhaust stream.

The exhaust sensor system 10 also includes an electronic control module 20. The electronic control module 20 includes a processor 22, and an electronic memory device 24. The electronic control module 20 also may include a control circuit 26 to control some or all of the operations of the sensor assembly 12. Alternatively, some or all of the control circuit 26 functionality may be implemented at the sensor assembly 12 or at another location that is not necessarily proximate the electronic control module 20. Additionally, in some embodiments, the control circuit 26 may control a peripheral system (not shown). Some examples of peripheral systems that may be implemented at the sensor assembly 12 include, but are not limited to, a heater (not shown) or a chemical neutralizer system (not shown). Instead of or in addition to the chemical neutralizer system, some embodiments may include an emission control element (not shown) to neutralize other aspects of the chemicals and/or substances within the exhaust system 106, either upstream or downstream from the sensor assembly 10. In other embodiments, the control circuit 26 may control peripheral systems at other locations within the exhaust sensor system 10.

In one embodiment, the sensor assembly 12 relays a sensor signal to the processor 22 of the electronic control module 20. The processor 22 analyzes the sensor signal from the sensor assembly 12. If the sensor signal is corrupted, the processor 22 may send a control signal to the control circuit 26, for example, to shut down the sensor assembly 12. In this situation, or in other situations, the control circuit 26 may activate one or more heaters inside of or within proximity to the sensor assembly 12 to burn off particulate matter deposits that might corrupt the sensor signal from the sensor assembly 12. In some embodiments, the processor 22 sends the control signal to the control circuit 26 to activate a chemical injection system to introduce a chemical agent into the exhaust system 16 to remove particulate matter deposits built up on the sensor assembly 12. Further functionality of embodiments of the control circuit 26 is described below.

If the sensor signal from the sensor assembly 12 is not corrupt, the processor 22 may compare the sensor signal with data stored in a lookup table 28 on the electronic memory device 24 to determine one or more qualities of the exhaust in the exhaust system 16. For example, the processor 22 may determine an amount of particulate matter in the exhaust stream. The processor 22 also may compare the sensor signal from the sensor assembly 12 with data from the lookup table 28 to estimate, for example, a mass concentration of particulate matter in the exhaust stream. In other embodiments, the electronic control module 20 facilitates detection of one or more other qualities of the gas in the exhaust system 16. For example, types of sensors that may detect qualities of the exhaust stream may include but are not limited to, a particulate matter sensor, an oxygen sensor, a thermal sensor, an ammonia sensor, a flow rate sensor, and an air-fuel ratio sensor.

It should also be noted that embodiments of the sensor assembly 10 may be tolerant of fluctuations of certain gaseous constituents in a gas environment. In this way, the sensor assembly 10 may be calibrated to measure particular chemicals, materials, or other conditions within an exhaust stream, with relatively little or no disruption from one or more other chemical substances and/or operating conditions.

It should also be noted that the sensor assembly 12 may be used, in some embodiments, to determine a failure in another component of the exhaust sensor system 10. For example, the sensor assembly 12 may be used to determine a failure of a particulate matter filter (not shown) within the exhaust system 16. In one embodiment, a failure within the exhaust sensor system 10 may be detected by an elevated signal generated by the sensor assembly 12. In some embodiments, the exhaust sensor system 10 includes an alarm to indicate a detected failure of the sensor assembly 12 or other component of the exhaust sensor system 10. In some embodiments, the sensor assembly 12 also could be coupled to another sensor or detector such as a mass flow meter.

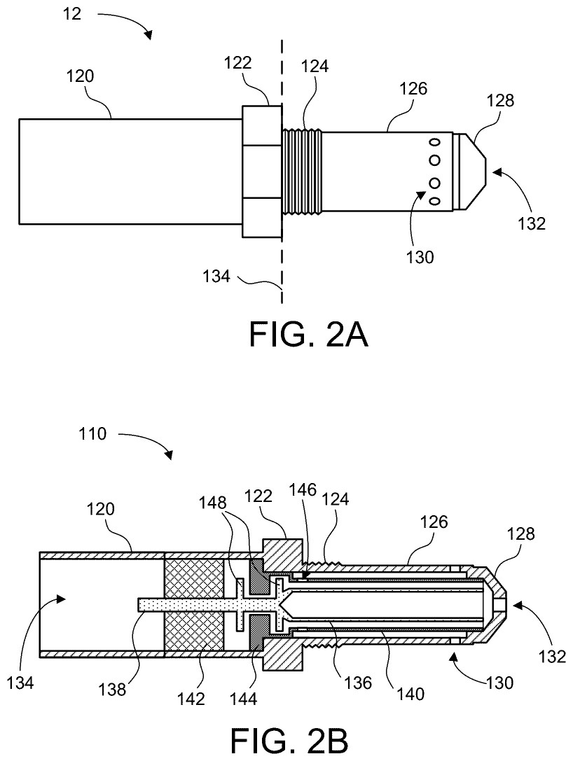

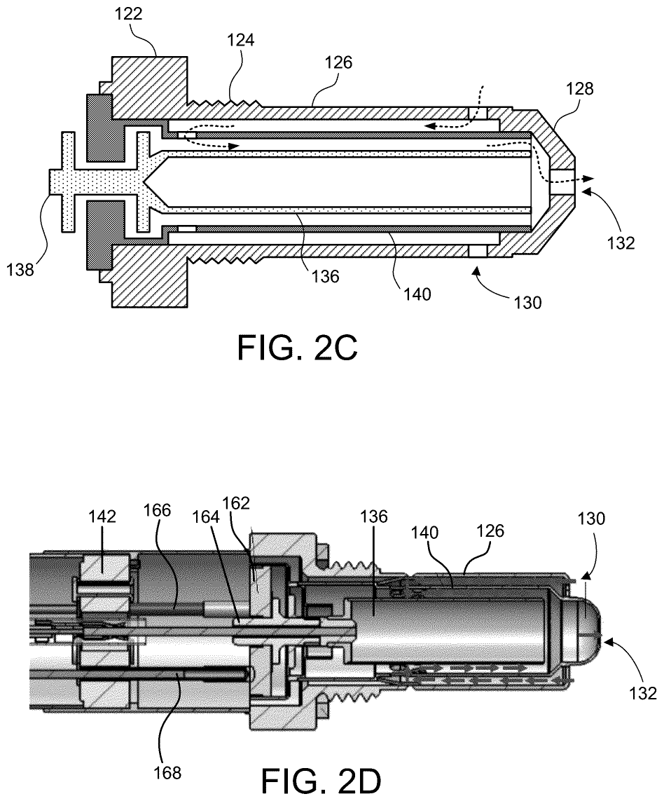

FIG. 2A depicts a schematic diagram of an exterior of one embodiment of the sensor assembly 12 of FIG. 1. FIG. 2B depicts a schematic diagram of an interior of one embodiment of the sensor assembly 12 of FIG. 2A. The illustrated external components of the sensor assembly 12 include a sensor housing 120, an intermediate bolt portion 122, and a threaded portion 124. The depicted external components also include an outer housing 126 with a cap 128. The outer housing 126 has one or more holes 130 which provide airflow within the outer housing 126. The cap 128 includes a separate opening 132 to facilitate the airflow within the outer housing 126. One example of an airflow pattern through the outer housing 126 of the sensor assembly 12 is shown in FIG. 2C and described in more detail below.

For reference, the sensor assembly 12 is installed within the exhaust sensor system 100 so that the sensor housing 120 and the bolt portion 122 of the sensor assembly 12 are typically outside of the exhaust stream through the exhaust system 106. The outer housing 126 and the cap 128 of the sensor assembly 12 are installed within the exhaust stream that passes through the exhaust system 106. The dashed line 134 distinguishes, generally, between the parts of the sensor assembly 12 that are outside (left of the dashed line 134) of the exhaust system 106 and the parts of the sensor assembly 12 that are inside (right of the dashed line 134) of the exhaust system 106. In one embodiment, the threaded portion 124 allows the sensor assembly 12 to be threaded, or screwed, into a corresponding hole within the exhaust system 106. Some of the threaded portion 124 may remain outside of the exhaust system 106 or, alternatively, may enter into the exhaust system 106. Many of the external components of the sensor assembly 12 may be made from metals, such as stainless steel, that are substantially insensitive to typical mechanical and/or chemical conditions within the exhaust sensor system 100.

In one embodiment, as exhaust gasses flow by the cap 128, the associated Venturi effect creates a low pressure which draws exhaust gas out of the interior of the outer housing 126. A corresponding amount of exhaust gas is drawn from the ambient exhaust stream through the holes 130 into the outer housing 126. Drawing a portion of the ambient exhaust stream into the outer housing 126 allows a sensor electrode 136 to measure the amount of particulate matter (PM) within the exhaust stream.

In one embodiment, the large surface area of the electrode 136 is cylindrically shaped. The cylinder can be hollow for weight reduction. The axis of the cylinder may be coincident with the axis of the electrode mounting stem 138.

FIG. 2B shows the inner construction of one embodiment of the sensor assembly 12. The inner construction of the sensor assembly 12 includes the sensor electrode 136 and the electrode mounting stem 138, as well as an inner baffle 140 and one or more insulators 142 and 144. In the depicted embodiment, the electric field extends radically between the surface of the electrode 136 and inner baffle 140. Because the electrode 136 has a smaller outside diameter than the inside diameter of inner baffle 140, the electric field is stronger at the surface of the electrode 136. In general, exhaust gas passing by the sensor assembly 12 enters into the outer housing 126 through the exhaust inlet holes 130. The exhaust gas flows through the space between inner baffle 140 and the outer housing 126 to one or more baffle holes 146 at the base of the inner baffle 140. The gas then flows in the space between cylindrical sensor electrode 136 and the cylindrical inner baffle 140 to the exhaust outlet 132 in the Venturi cap 128.

Because the flow of exhaust gas has to make a 90 degree turn when flowing from the holes 146 in the inner baffle into the space between the inner baffle 140 and the electrode 136, particles suspended in the gas stream are accelerated towards the electrode 136 because of their higher inertia compared to gas molecules. This flow pattern further supports the formation of particle agglomerates on the electrode 136.

In one embodiment, the inner baffle 140 is metallic and connected to the ground. The Venturi cap 128 is also connected to the inner baffle 140 and grounded.

Agglomerates that detach from the electrode 136 are repelled by the electrode 136 due to having equal charge and are attracted by the surface of the inner baffle 140, which has an opposite surface charge to the electrode 136 or agglomerates. Because detached particle agglomerates flow with the gas stream between inner baffle 140 and electrode 136, and because the gas stream has to execute two more turns to exit through the Venturi hole 132, these turns in the flow further insure that even agglomerates that have not deposited their charge in the inner baffle 140 are accelerated by their inertia towards a grounded surface part of the Venturi cap 128.

The grounded filter baffle 144 and the high voltage filter baffles 148, which are disk shaped, provide a tortuous path for particles that could migrate to the electrode insulator 142. The electric field between these filter baffles is highly inhomogeneous at the inner edge of filter baffle 144 and at the outer edges of filter baffles 148. Therefore, any particulates that migrate along the path between those filter baffles are attracted to these filter baffles themselves and will attach there. The normal gas flow path through the sensor insures that there will not be enough soot particles migrating to create large structures. The filter baffles therefore slow down particle accumulation on the insulator 142. Particle accumulations on the insulator 142 could form an electrically conductive path that will create a charge loss from electrode 136 to the sensor housing 120, parallel and in addition to the charge loss by particle agglomerates, which could detrimentally affect sensor performance. In addition, in some embodiments, the insulator 142 could be periodically heated by an embedded heater (not shown) such that any accumulated soot particles on the surface of the insulator 142 are burned off.

In some embodiments, this burn-off of soot particles may be implemented infrequently. Even in exhaust gas with particle concentrations far above the legal limit for emissions, the burn-off may be required only every few hours of operation.

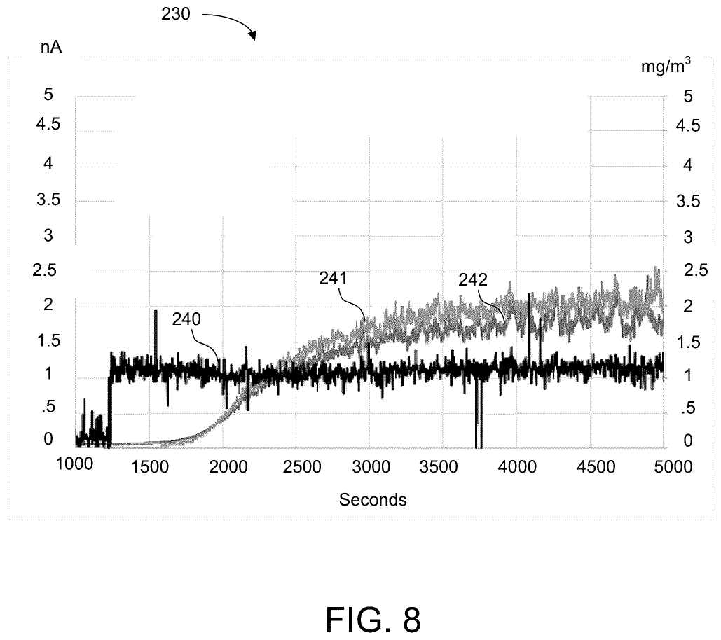

FIG. 2D depicts a schematic diagram of another embodiment of the sensor assembly 12 of FIG. 1. In contrast to the sensor assembly of FIG. 2B, the sensor assembly of FIG. 2D includes a heater assembly 162 (also referred to as a heater disk 162). The heater assembly 162 may perform some or all of the insulating functions of the insulator 144 of FIG. 2B. Additionally, the heater assembly 162 may perform one or more of the heater functions described herein. A more detailed depiction of the heater insulator assembly 162 is shown in FIGS. 7, 8A, and 8B and described in more detail below. The illustrated sensor assembly of FIG. 2D also includes a heater bushing 164, and separate electrical leads 166 and 168 for the heater and ground traces (see FIGS. 7, 8A, 8B). In general, the heater may be controlled to provide heat to the adjacent electrically insulating surfaces so as to burn off deposited particles that may have settled on or otherwise coupled to the insulating surfaces. Additionally, the heater supply heat to the sensor electrode 136, or a portion thereof, to burn off some or all of the soot or deposited particles at the heated location(s). The heater bushing 164 provides an insulated pathway for the corresponding portion of the sensor electrode 136 to pass through the heater insulator assembly 162.

In operation, exhaust gas flowing past the Venturi tip 128 of the sensor assembly 2 creates a low pressure area at the tip. Flow through the sensor assembly 12 is also promoted by a positive pressure that is created at the “inlet holes” 130 because of the velocity head (velocity is reduced to zero at the inlet holes and velocity is converted to pressure at the inlet holes by Bernoulli's principle). The low pressure at the tip 128 combined with the positive pressure at the inlet holes 130 draw exhaust gas through the sensor in a reproducible manner. The exhaust gas flows up through the space between exhaust housing and inner baffle and through holes 146 in the inner baffle 140 into the space between inner baffle 140 and electrode 136 and back down towards the Venturi hole 132. Although different operating conditions may be achieved, on example of a model of the illustrated embodiment exhibits a free stream exhaust velocity of 14 m/s and an exhaust gas temperature (EGT) of 200 C. At these conditions, the velocity in the sensor is 0.34 m/s (Re=25), and the volumetric flow rate is 0.82 liters/minute.

In one embodiment, the sensor body, including the inner baffle 140, is grounded through the vehicle exhaust system to the vehicle ground (not shown). The cylindrical electrode 136 is held at a potential of approximately 1,000 V relative to ground. In the depicted embodiment, the electrode 136 and its connections are insulated with two alumina discs: the back insulator disk 142, which also acts as holder for the heater and guard connections, and the heater disk 162. The heater disk 162 also mechanically fixes the electrode 140 assembly in the sensor 12. In one embodiment, one or both of the insulator disks 142 and 162 are co-fired. In some embodiments, the heater disk 162 contains a platinum thick-film heating element (see FIGS. 7, 8A, 8B) that serves also as resistance temperature detector (RTD) for temperature measurements. The heater element can be used to evaporate moisture that condenses on the heater disk 162 during condensing conditions, and as mentioned above can also be used to burn off soot that accumulates on the exhaust side face of the heater disk 162 over time. Under some operating conditions the function of burning off soot may be used infrequently, as needed.

In one embodiment, the electrode 140 assembly is brazed to the heater bushing 164, which acts as the main insulator between the electrode 136 and heater disk 162. The hole in the heater disk 162 in which the heater bushing 164 is brazed is surrounded on both sides of the heater disk by metalized guard rings (see FIGS. 7, 8A, 8B). These guard rings are electrically connected to the brazing metal in the heater disk 162 (e.g., to a heater bushing braze joint) and connected to the “guard” connection 166. Similar guard rings may be implemented on one or both of the outermost surfaces of the heater disk 162 (See FIGS. 8A and 8B). These guard traces are further connected to the inner shield of a triaxial sensor supply cable (guard), while the inner conductor of the triaxial cable supplies the high potential for the electrode 136. The outer conductor of the triaxial cable is connected on the electronic side to ground to provide RF and capacitive noise shielding.

The electronics for the sensor 12 hold the guard connection at ground potential while the guard itself is connected to the negative side of the 1,000 V supply. Therefore, any current leakage through either the bulk resistivity of the heater bushing 164, or due to conducting surface contaminants on heater disk 162 or back insulator between the electrode 136 and the guard trace creates a current load on the HV power supply, but does not contribute to a current measured between the negative of the 1,000 V supply and ground.

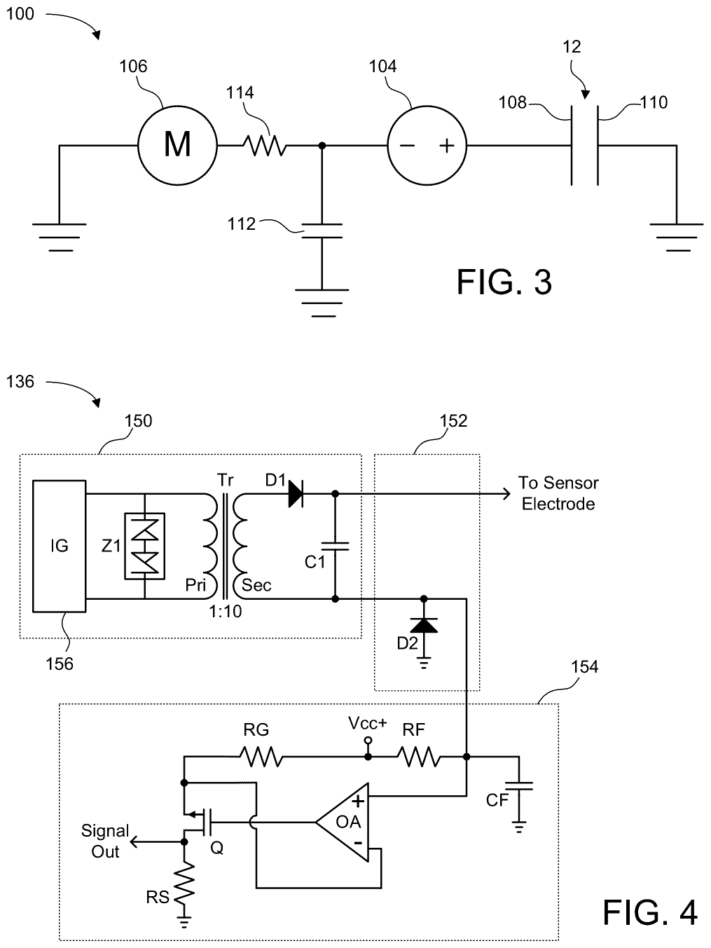

FIG. 3 depicts an electrical schematic block diagram of one embodiment of the control circuit of FIG. 1.

The positive connection of the high voltage source 104 is connected to the electrode 108 of sensor assembly 12, while the inner baffle 140 and the rest of the sensor assembly 12 are connected to ground. This rest of the sensor assembly 12 is depicted as part 110 in the electrical schematic block diagram. The negative connection of the high voltage source 104 is connected to one side of the filter resistor 114 and to one side of the filter capacitor 112. The other side of filter capacitor 112 is grounded. The other side of the resistor 114 is connected to one side the current meter 106, and the other side of the current meter 106 is grounded.

The resistor 114 and filter capacitor 112 form a low pass filter with a bandwidth of, for example, 5-10 Hz. The current pulses created by the operation of sensor assembly 12 are integrated in this low pass filter.

FIG. 4 depicts a more detailed electrical schematic of the schematic block diagram depicted in FIG. 3. Generally, the illustrated control circuit 26 includes a generator block 150, a protection block 152, and a detection and filter block 154. Other embodiments may include fewer or more blocks and/or fewer or more components within one or more of the illustrated blocks.

In the depicted embodiment, the generator block 150 includes an impulse generator (IG), a bi-directional Zener diode (Z1), a transformer (Tr), a high voltage diode (D1), and a high voltage capacitor (C1). The illustrated transformer includes primary and secondary windings with a 1:10 winding ratio, although other embodiments may have different winding ratios. The protection block 152 includes the clamping diode D2. The detection block 154 includes an initial filter resistor (RF), an initial filter capacitor (CF), an operational amplifier (OA), a gain resistor (RG), a PMOS transistor (Q), and a current to voltage conversion resistor (RS).

In general, the control circuit 26 generates a relatively high voltage to apply to the sensor electrode 108 and, in turn, generates an output signal that can be correlated with the particulate matter level of the exhaust stream to which the sensor electrode 108 is exposed. Specifically the secondary side of the transformer TR, diode D1, and capacitor C1 form an embodiment of the floating voltage source 108 depicted in FIG. 3. While specific circuit components are shown in a particular arrangement, other embodiments may use similar or different circuit components to achieve the same or similar results. Additionally, while the illustrated circuit is implemented substantially in hardware, it may be possible to implement some portions of the control circuit 26 using software instructions that are executed by a central processor or other digital signal processing device.

In one embodiment, the impulse generator 156 generates periodic, short pulses duration (e.g., about 1-2 μsec) with a particular repeat rate (e.g., about 1400 impulses per second) and a maximum amplitude (e.g., about 1000V). These impulses charge the capacitor C1 to the same amplitude (e.g., about 1000V). The positively charged side of capacitor C1 is connected to the sensor electrode 108 of the sensor assembly 100. Agglomerates that get positively charged at the sensor electrode 108 carry away some of the capacitor charge periodically and, thus, discharge the capacitor C1 relative to the ground reference (e.g., vehicle ground). This discharge current flows through the initial filter resistor RF and are integrated at the initial filter capacitor CF. The operation amplifier OA together with the gain resistor RG and PMOS transistor Q form an inverting current amplifier with a gain of −RF/RG. This amplified current Iout flows out of the drain of PMOS transistor Q into the voltage conversion resistor RS. The voltage at resistor RS is therefore proportional to RS*Iout, according to Ohms law. Other methods of detecting the discharge current can be employed as well.

In one embodiment, the impulse generator 156 receives vehicle battery voltage (about 12V) and switches the vehicle battery voltage on the primary winding of the transformer until the current in this winding reaches a primary winding threshold value. In one embodiment, the primary winding threshold value is approximately 3 Amperes, although other embodiments may use a different primary winding threshold value. When the specified current limit is reached, the current is rapidly switched off. In one embodiment, the inductive flyback pulse of the primary winding is limited by the bidirectional Zener diode Z1 to a value of 100V. Because the transformer has a winding ratio of 10:1 between its secondary and primary windings, the flyback pulse limited to 100V on the primary side translates into a 1000V pulse on the secondary side. Although some embodiments may use 100V on the primary side and 1000V on the secondary side, other embodiments may use different voltages and/or different winding ratios.

The impulse generator 156 periodically switches the battery on to the primary winding to generate corresponding pulses on the secondary side on a regular basis. In one embodiment, pulses are generated once every 0.7 msec (1.4 kHz), although other embodiments may use a different pulse generation frequency.

The 1000V pulse on the secondary side of the transformer charges the high voltage capacitor C1 via the diode D1 to 1000V. This circuit is a flyback converter with primary voltage limiting.

The 1000V charge of the high voltage capacitor C1 is connected to the sensor electrode 108.

If soot agglomerates extend all the way from the sensor electrode 108 to the grounded part 110 of the sensor assembly, a short circuit would form that shorts the high voltage source to ground. This creates a high current that would discharge C1 rapidly while CF would be charged rapidly to a high negative voltage. The protection diode D2 prevents CF to be charged to a more negative voltage than about −0.7V. The high discharge current of C1 will heat up the particles of which the shorting soot agglomerate is formed to a high enough temperature to burn them. This way these types of short circuits are self extinguishing.

The negative side of high voltage capacitor C1 is connected to the initial filter resistor RF and initial filter capacitor CF. The filter capacitor CF integrates the current pulses caused by dislodged soot agglomerates as described before. Therefore the average current through RF is proportional to the charge loss rate from the electrode caused by dislodging soot agglomerates depositing their charge to a grounded part of the sensor or exhaust system. This integrated current is correlates with the soot concentration of the exhaust gas flowing through the sensor. Because of the need for integration of the current pulses, this sensors response time is determined by the low pass filter bandwidth of the low pass filter formed by RF and CF. For typical implementations, this bandwidth is less than 10 Hz.

The exhaust sensor system 10 also includes an electronic control module 20. The electronic control module 20 includes a processor 22, and an electronic memory device 24. The electronic control module 20 also may include a control circuit 26 control some or all of the operations of the sensor assembly 12. Alternatively, some or all of the control circuit 116 functionality may be implemented at the sensor assembly 12 or at another location that is not necessarily proximate the electronic control module 20. Additionally, in some embodiments, the control circuit 26 may control a peripheral system (not shown). Some examples of peripheral systems that may be implemented at the sensor assembly 12 include, but are not limited to, a heater (not shown) or a chemical neutralizer system (not shown). Instead of or in addition to the chemical neutralizer system, some embodiments may include an emission control element (not shown) to neutralize other aspects of the chemicals and/or substances within the exhaust system 106, either upstream or downstream from the sensor

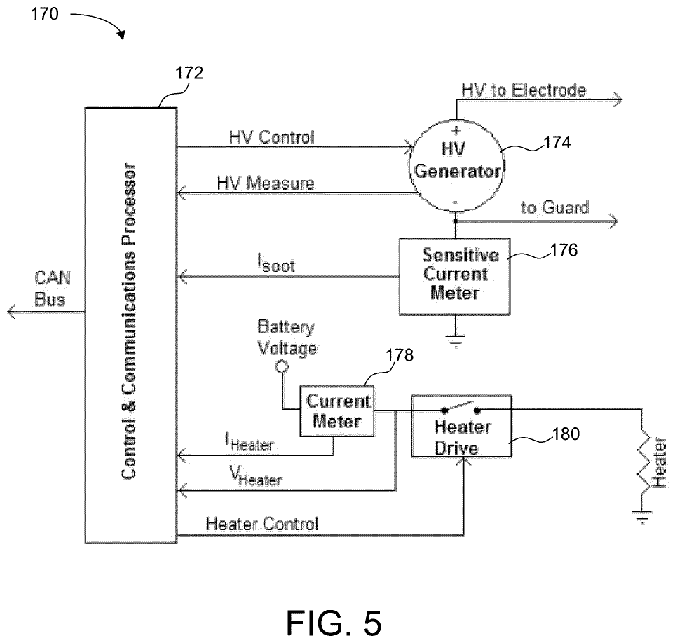

FIG. 5 depicts a schematic circuit diagram of the sensor assembly of FIG. 1. The illustrated circuit diagram includes a processor 172, a high voltage generator 174, a sensitive current meter 176, a current meter 178, and a heater drive 180 to control the heater. The illustrated circuit diagram also includes several control and/or communication lines. In one embodiment, the electrode 136 is connected to the positive side of the high voltage generator 174, and the guard trace is coupled to the negative side of the high voltage generator 174. Current measured by the sensitive current meter 176 may be reported to the processor 172, which can correlate the measured current to a characterization of the particulates in the exhaust gas to which the electrode 136 is exposed. More generally, the control and communications processor coordinates all measurements, does the analog to digital conversions, controls the operation of the HV generator, processes the data, and communicates the results via a CAN bus.

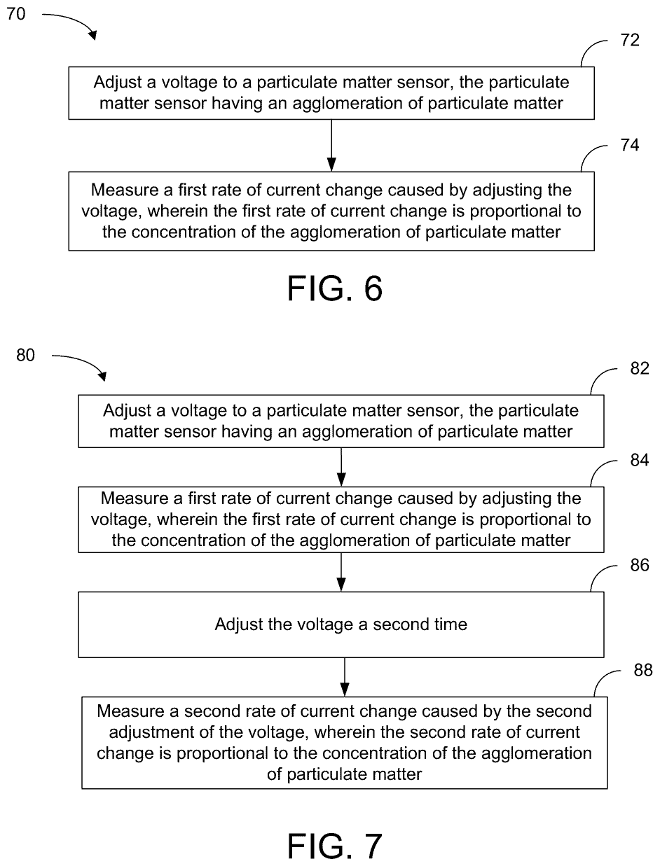

FIG. 6 depicts one embodiment of a flow chart diagram of a method 70 for measuring a concentration of particulate matter. The method includes adjusting 72 a voltage to a particulate matter sensor, the particulate matter sensor having an agglomeration of particulate matter. The method 70 also includes measuring 74 a first rate of current change caused by adjusting the voltage, wherein the first rate of current change is proportional to the concentration of the agglomeration of particulate matter.

FIG. 7 depicts one embodiment of a flow chart diagram of a method 80 for measuring a concentration of particulate matter. The method includes adjusting 82 a voltage to a particulate matter sensor, the particulate matter sensor having an agglomeration of particulate matter. The method 80 also includes measuring 84 a first rate of current change caused by adjusting the voltage, wherein the first rate of current change is proportional to the concentration of the agglomeration of particulate matter. The method includes adjusting 86 the voltage a second time. The method includes measuring 88 a second rate of current change caused by the second adjustment of the voltage, wherein the second rate of current change is proportional to the concentration of the agglomeration of particulate matter.

Some embodiments rely on development and destruction of the amplification, not the full amplification itself. In some embodiments, the system uses soot for large current transfer (“amplification”) to occur. There is no discernible current, then current starts to rise, and eventually reaches a max. This ramp up time is non trivial and can be, for example, minutes on a test engine, or even multiple hours at low concentrations. Although some conventional system wait for the system to reach stable equilibrium, then use the current as a real-time soot measurement, there is typically a long light off time (that is hard to determine) and the signal is often disrupted by transient events. Instead of this conventional approach, in some embodiments the system uses a relatively high, or even the highest possible, voltage without arcing to encourage the phenomenon to begin. Once a rise is detected, the voltage is lowered and the phenomenon is stopped. Subsequently, the voltage may be raised again to restart another cycle of the process. Instead of taking the system to full amplification and equilibrium, measurements may be obtained of the current rise for a fixed interval of time. Then the voltage may be lowered again and the rate of decay may be measured.

It is expected that the rate of rise should change with soot concentration. There are possible advantages to this approach, including the following: Although in conventional systems the equilibrium is held and then determined when it is not valid, embodiments of a new approach attempt to induce a phenomenon-voltage rise, current rise, voltage drop, current drop. In other words, instead of a continuous measurement and an attempt to determine when it is valid, a sequence of measurements is obtained, each measurement being relatively short in duration. This should make disrupted measurements easier to discard (where the rate of change is too fast or is in an opposite direction), and those that slip by to have a smaller effect when integrated with the other measurements.

If less soot is held in electrostatic equilibrium, flow transients might have less influence because of different total number of dendrites at critical length and less captured mass. Less captured soot might also lead to less fouling.

In some embodiments, the system measures rate of change for two voltages. Although the exact current transfer mechanism(s) are not necessarily fully understood, depending on the source(s) and relative contributions, amplification rise time might have a correlation to PSD as well as particulate charge distribution (PCD). In this scenario, measuring two points again and again provides two points on a Boltzmann distribution curve, and a way to guess at PN, or at least particle surface charge.

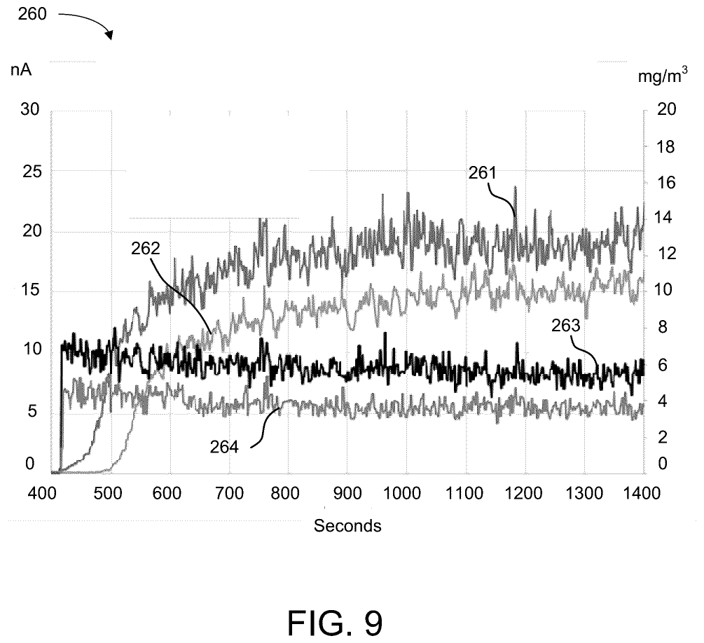

FIG. 9 illustrates a non-trivial lag in signal formation that can be averted by adjusting the voltage and measuring the rate of current change.

FIG. 8 illustrates a graphical representation 230 of buildup and current level and graphical illustrates the rate of change of current. The Figure illustrates an observation that the signal develops more slowly at lower soot concentrations. However, instead of waiting hundreds or thousands of seconds for a steady state equilibrium to develop, in some embodiments the sensor system only applies the field long enough for the signal to start to develop, as shown in FIG. 8. The graph shows new startups 241, 242 and buildup 240.

How fast the current is rising during a fixed period of time from a change first being detected would reflect soot concentration. The faster the rise, the more soot.

After the measurement is made, the voltage may be ramped down to a level where the current begins falling. In the sample of FIG. 9, this might shorten sensor response time to approximately 550 seconds. FIG. 9 illustrates a graphical representation 260 of buildup and current level and graphical illustrates the rate of change of current. The graph shows a current level 262 and associated buildup 264 as well as another current level 261 and associated buildup 263.

Although embodiments described herein work with a simple on/off for high voltage, other embodiments may lower the voltage just modestly (10-20V) in order to stop the amplification effect. Some advantages to ramping down the voltage modestly are potentially twofold. First, the entire aggregate structure is not suddenly discarded, making subsequent measurements potentially faster than the first. In other words, soot is demonstrably collecting inside the sensor long before a detectable current rise occurs. Shutting the voltage off completely could cause the loss of all that soot, but lowering the voltage more gradually, a smaller amount, appears, in lab experiments, to keep much of the previously collected material trapped.

Second, determining how much voltage must be removed to stop amplification development could be a second potential measurement of current PM concentration.

In some embodiments, a variable voltage source could also potentially be used to address other issues. For example, in one embodiment, a signal greater than 1000V is applied to the sensor which might result in a faster initial response and less susceptibility to transient flow events. However, higher voltages are much closer to the dielectric breakdown of hot exhaust gas. Nevertheless, a fixed 4000 VDC supply would only work part of the time, when atmospheric conditions and gas temperature are suitable. Other embodiments may operate between 1000-4000 VDC. In further embodiments, a fixed supply greater than 4000 VDC may be applied temporarily.

In another example, a variable voltage system could raise the voltage until arcing is detected (high current spike) then slightly reduce it, making the sensor response as fast as possible for the current operating conditions.

Conversely, in another example, voltage could be lowered to determine how much bulk and surface leakage is occurring and must be removed from the signal. Again, this relies on the amplification being a fairly fragile effect.

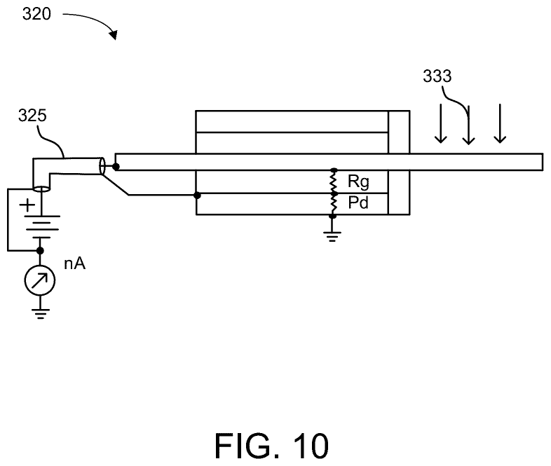

In a specific embodiment, the bulk and surface leakage may be removed using a guard trace system that is extended through the sensor proper, as shown in FIG. 10. FIG. 10 illustrates a particulate matter sensor 320 with shielding 325 and exhaust flow 333 over the sensor. This type of system might work quite well, but could add complexity and cost. If the voltage is lowered to the point where current amplification is not occurring, then any measured current would be the result of leakage (surface contamination, bulk leakage, cable breakdown, etc.). This would permit the leakage to be differentiated from the ‘real’ signal.

However, this type of differentiation is not necessarily required for embodiments of the measurement method described herein. Rather, embodiments described herein rely on rate-of-change for current, so it might not matter what the absolute current is, only how much it has risen or fallen in a period of time.

In some embodiments, detecting and quantifying leakage could be useful for non-measurement purposes. At a normal operating temperature of 300 C EGT in diesel exhaust, some bulk leakage will occur in a ceramic insulator. Detecting this leakage would establish that the sensor is physically connected and high voltage is reaching it. This could be useful in meeting regulatory compliance and OEM customer needs without adding any additional circuitry or complexity.

Similarly, quantifying the amount of leakage could be used to detect imminent failure of the sensor from soot fouling, etc.

In some embodiments, it is possible that discharge events may be happening at a very small scale. In these embodiments, there might be a relationship between soot surface area and rate of startup. If this relationship exists, further information might be able to be measured.

Instead of applying a single higher voltage and waiting for current to rise, measurements at two different voltages could be alternated. For example: 1000V, 1050V, 1000V, 1050V . . . .

If there is a relationship to surface area, then the measurements would by particle size distribution (PSD). PSD is normally presumed to follow a so called Boltzmann Distribution in combustion exhaust.

In some embodiments, measuring two points on a Boltzman Distribution curve, or altering values to find the peak of the curve, provides a way to report PSD or particle number (PN) instead of approximate total mass.

It should be noted that at least some of the operations for the methods may be implemented using software instructions stored on a computer useable storage medium for execution by a computer. As an example, an embodiment of a computer program product includes a computer useable storage medium to store a computer readable program that, when executed on a computer, causes the computer to perform operations, including an operation to detect an affected waveform and compare the affected waveform against an original waveform to determine at least one characteristic of a gas stream.

Some embodiments described herein may include at least one processing device coupled directly or indirectly to memory elements through a system bus such as a data, address, and/or control bus. The memory elements can include local memory employed during actual execution of the program code, bulk storage, and cache memories which provide temporary storage of at least some program code in order to reduce the number of times code must be retrieved from bulk storage during execution.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the invention can take the form of an entirely hardware embodiment or an embodiment containing both hardware and software elements. In one embodiment, the invention is implemented in software, which includes but is not limited to firmware, resident software, microcode, etc. on a hardware device such as a processor, a memory device, or another device capable of storing non-transient signals and/or processing related signals.

Furthermore, embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The computer-useable or computer-readable medium can be an electronic, magnetic, optical, electromagnetic, infrared, or semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include a compact disk with read only memory (CD-ROM), a compact disk with read/write (CD-R/W), and a digital video disk (DVD).

Input/output or I/O devices (including but not limited to keyboards, displays, pointing devices, etc.) can be coupled to the system either directly or through intervening I/O controllers. Additionally, network adapters also may be coupled to the system to enable the data processing system to become coupled to other data processing systems or remote printers or storage devices through intervening private or public networks. Modems, cable modems, and Ethernet cards are just a few of the currently available types of network adapters.

In the above description, specific details of various embodiments are provided. However, some embodiments may be practiced with less than all of these specific details. In other instances, certain methods, procedures, components, structures, and/or functions are described in no more detail than to enable the various embodiments of the invention, for the sake of brevity and clarity.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method for analysis of a gas stream, the method comprising:
adjusting a voltage to a particulate matter sensor, the particulate matter sensor having an agglomeration of particulate matter; and
measuring a first rate of current change caused by adjusting the voltage, wherein the first rate of current change is proportional to the concentration of the agglomeration of particulate matter.

2. The method of claim 1, further comprising:
adjusting the voltage to the particulate matter sensor a second time; and
measuring a second rate of current change caused by adjusting the voltage the second time, wherein the second rate of current change is proportional to the concentration of agglomeration of particulate matter.

3. The method of claim 2, wherein the adjusting the voltage to the particulate matter sensor comprises increasing the voltage, and wherein adjusting the voltage to the particulate matter sensor the second time comprises decreasing the voltage.

4. The method of claim 2, wherein the adjusting the voltage to the particulate matter sensor comprises decreasing the voltage after a fixed interval of time of a constant voltage.

5. The method of claim 2, wherein the adjusting the voltage to the particulate matter sensor comprises increasing the voltage to a range between 1 kilovolt and 1.6 kilovolts.

6. The method of claim 2, further comprising turning off the voltage and measuring a fall rate of the current.

7. The method of claim 2, further comprising adjusting the voltage to the particulate matter sensor intermittently.

8. The method of claim 7, further comprising measuring the rate of current change intermittently.

9. The method of claim 2, further comprising adjusting the voltage to the particulate matter sensor periodically.

10. The method of claim 9, further comprising measuring the rate of current change periodically.

11. The method of claim 1, wherein the adjusting the voltage to the particulate matter sensor comprises increasing the voltage.

12. The method of claim 1, wherein the adjusting the voltage to the particulate matter sensor comprises decreasing the voltage.

13. The method of claim 1, wherein the adjusting the voltage to the particulate matter sensor comprises decreasing the voltage after a fixed interval of time of a constant voltage.

14. The method of claim 1, wherein the adjusting the voltage to the particulate matter sensor comprises increasing the voltage to a range between 1 kilovolt and 5 kilovolts.

15. The method of claim 1, further comprising turning off the voltage and measuring a fall rate of the current.

16. The method of claim 1, further comprising adjusting the voltage to the particulate matter sensor intermittently and further comprising measuring the rate of current change intermittently.

17. The method of claim 1, further comprising adjusting the voltage to the particulate matter sensor periodically and further comprising measuring the rate of current change periodically.

18. A device for analysis of a gas stream, the device comprising:
a particulate matter sensor;
a voltage generator to generate an adjustable voltage;
a detector configured to detect a rate of current change caused by an adjustable voltage.

19. The device of claim 18, wherein the voltage generator is configured to increase or decrease the voltage.

20. The device of claim 18, wherein the voltage generator is configured to adjust the voltage intermittently.
